(19) United States
(12) Patent Application Publication
(10) Pub. No.: US 2013/0058185 A1
(43) Pub. Date: Mar. 7, 2013

(54) METHOD AND DEVICE FOR OPERATING AND WASHING A DESSERT MAKER

(71) Applicant: Asbjorn Hansen, SR., Drammen (NO)

(72) Inventor: Asbjorn Hansen, SR., Drammen (NO)

(73) Assignee: MARIENLYST EIENDOM AS, Drammen (NO)

(21) Appl. No.: 13/223,901

(22) Filed: Sep. 1, 2011

(51) Int. Cl. B01F 15/00; B01F 7/00

(52) U.S. Cl. 366/138

(57) ABSTRACT

A method for ensuring continuous and hygienic operation of a mixing apparatus for mixing frozen desserts in a mixing chamber formed by a top chamber and a funnel brought together, wherein a spindle with a driving portion is accommodated through the top chamber, includes checking whether a predetermined time has passed since a last rinsing or washing operation has been performed, disabling mixing operation and notifying that a rinsing or washing operation is required if the predetermined time has passed, enabling mixing operation if the predetermined time has not passed, initiating a rinsing process when selected, initiating a washing process when selected, and performing a mixing operation of frozen desserts when enabled and selected.

### FIELD OF THE INVENTION

The present invention describes a method and device for operating and controlling an apparatus for mixing frozen desserts. More specifically the invention describes details of a method for operating and washing a dessert maker.

### BACKGROUND OF THE INVENTION

A mixing apparatus for mixing ice cream and other frozen desserts with one or more additives typically comprises a funnel for holding the frozen dessert and additives, an auger with a spindle for creating a mixing action, an auger driver for rotating the auger spindle, and a linear actuator for relative movement of the funnel and auger into a position in which the auger is telescoped into the funnel, in which position a rotation of the auger will mix the different ingredients of the frozen dessert. The following disclosure relate to a mixing apparatus for making ice cream, and especially to an improved mixing apparatus for providing easy maintenance and cleaning.

Ice cream is normally in hard form, while flavor additives may be fruits or nuts. The result of such a mixing is a semi-liquid ice cream in which the flavor additives are more or less distributed before being dispensed from the mixing apparatus.

Such apparatuses are known from a number of patents, e.g., U.S. Pat. No. 6,341,887 and U.S. Pat. No. 6,318,889 describing apparatuses comprising an auger or agitator with a helical thread or cutter extending into a funnel or container for holding the ice cream and additives. The auger and funnel are relatively rotatable, and after some rotation the ice cream and additives have obtained a desired semi-liquid condition.

### SUMMARY

An issue with apparatuses known from said prior art is maintenance and cleaning. Due to the construction of a mixing chamber made in one closed piece, maintenance and cleaning of the chamber is cumbersome and can not be performed efficiently.

There is thus a need for an improved method for ensuring a continuous and hygienic production of frozen desserts.

The applicant has developed a mixing apparatus facilitating better maintenance and cleaning of a mixing apparatus. To enhance the usability of the dessert maker and for hygienic reasons, the dessert maker has a mixing chamber made up of two main parts comprising a funnel and a top chamber forming a closed mixing chamber when brought together. A spindle is accommodated through the top chamber. Water spray nozzles are further provided in the top chamber. The mixing apparatus also comprises a water heater as well as a detergent container.

One or more embodiments of the present invention presents a method for ensuring continuous and hygienic operations of such dessert maker.

A method according to one or more embodiments of the present invention for ensuring continuous and hygienic operation of an apparatus for mixing frozen desserts in a mixing chamber formed by a top chamber and a funnel brought together, and where a spindle with driving means is accommodated through said top chamber, said method comprises the following steps:
checking whether a predetermined time has passed since a last rinsing or washing operation has been performed;
if a predetermined time has passed, then disabling mixing operation and notify that a washing procedure is required;
if a predetermined time has not passed, then enable mixing operation;
initiating a rinsing process when selected;
initiating a washing process when selected, and
initiating mixing operation of frozen desserts when enabled and selected.

One or more embodiments of the present invention comprises a device for performing said method.

It should be understood that the detailed description and specific examples, while indicating embodiments of the invention are given by way of illustration only, since various changes and modifications within the spirit and scope of the invention will become apparent to those skilled in the art.

### BRIEF DESCRIPTION OF THE DRAWINGS

FIG. 1 shows a complete and ready to use set-up of the mixing apparatus according to one or more embodiments of the present invention, and

FIG. 2 is a flowchart of the method operation of the mixing apparatus according to one or more embodiments of the present invention.

### DETAILED DESCRIPTION

Embodiments of the invention will be described below with reference to the accompanying drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

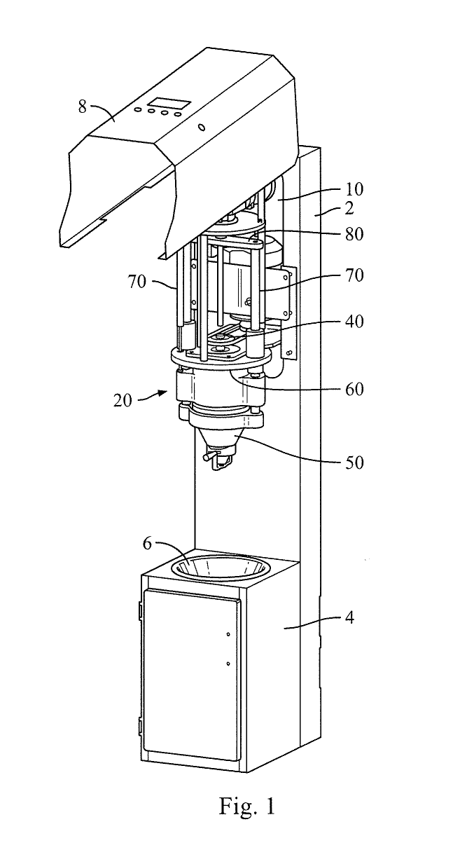

FIG. 1 shows a complete mounted and ready to use set-up of the mixing apparatus 10 for frozen desserts according to one or more embodiments of the present invention. The figure shows the apparatus 10 for mixing frozen desserts mounted on a rack 2. When in use, the mixing apparatus 10 is protected by a lid 8 (shown in a lifted position). The figure further shows a cabinet 4 with a sink 6 located below the mixing apparatus 10. The sink is used when performing a cleaning operation of the mixing apparatus 10.

The mixing apparatus 10 comprises a mixing chamber 20 and a spindle 30 with driving means 40 for rotating the spindle 30. The spindle 30 has the shape of a conical screw. The mixing chamber 20 is where the frozen dessert, e.g. ice cream and flavour additives, is held and mixed.

The mixing chamber 20 is made up of two main parts comprising a funnel 50 and a top chamber 60 forming a closed mixing chamber 20 when brought together. The spindle 30 is accommodated through the top chamber 60.

Said funnel 50 comprises a valve assembly with a design that is advantageous with regards to maintaining high hygiene and easy cleaning. It is easy to remove and clean the parts in contact with the frozen dessert.

The mixing apparatus 10 has a self contained washing system comprising water heater, containers for detergent and disinfectant, dosing units, and a device for controlling rinsing and washing procedure, i.e. controlling temperature, supply of detergent and disinfectant.

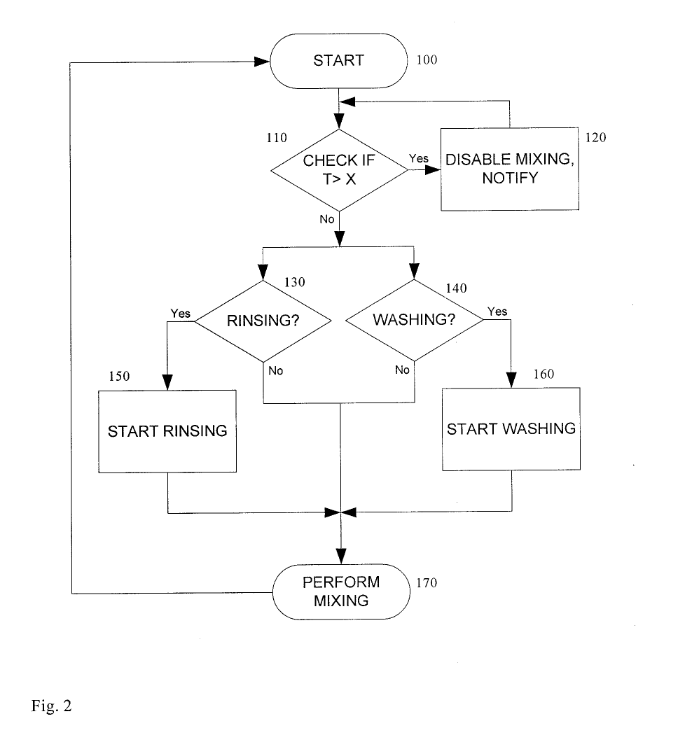

FIG. 2 is a flowchart of the method for ensuring continuous and hygienic operation of a mixing apparatus 10 for mixing frozen desserts in a mixing chamber 20 formed by a top chamber 60 and a funnel 50 brought together, and where a spindle 30 with driving means is accommodated through said top chamber 60. The method comprises several steps.

The method is implemented in a device with control software controlling the operation of the mixing apparatus 10. When an operator, through input means, indicates that the mixing apparatus 10 is to be used, the status of the apparatus is first checked. Depending on the status, mixing operation will be enabled or disabled.

When it is indicated that the mixing apparatus is to be used the controlling of the operation starts 100. It is first checked 110 if a predetermined time has passed since last rinsing or washing operation was performed. This is to ensure that the different parts in contact with the dessert to be mixed are clean.

If a predetermined time has passed, mixing operation is disabled 120 and the mixing apparatus will notify that a rinsing or washing operation is required. The notification can be visual through information on a text display or a blinking lamp. It may also be a notification in the form of a sound, or a combination of these. The mixing operation will stay disabled until a rinsing or washing operation is performed.

A rinsing or washing operation can be performed by a manual or an automatic operation.

When a manual rinsing or washing operation is chosen, the mixing apparatus will stay in standby with mixing operation disabled until an operator initiates a rinsing or washing procedure.

When an automatic rinsing or washing operation is chosen, the mixing apparatus will automatically initiate and perform a rinsing or washing operation. Which operation to perform can be programmed and depend on the time passed since last operation, i.e. mixing, rinsing or washing. The programming can be performed locally or remotely via network means.

A rinsing procedure is not as thorough as a washing procedure. A rinsing procedure is performed by several steps. First, the funnel 50 and the stationary top chamber 60 are brought together thus forming a closed mixing chamber 20. Next, the spindle 30 is rotated, and it is checked whether the valve at the bottom of the funnel 50 is open. If said valve is open then water is applied through water spray nozzles that are directed at the spindle 30 mounted in the top chamber 60. In the last step, the funnel 50 is lowered after the rinsing has finished.

A washing procedure is performed by several steps. First, the funnel 50 and the stationary top chamber 60 are brought together forming a closed mixing chamber 20. Next, the spindle 30 is rotated, and it is checked whether the valve at the bottom of the funnel 50 is open. If said valve is open then detergent at hot water is applied through water spray nozzles that are directed at the spindle 30 and mounted in the top chamber 60. In the last step, the funnel 50 is lowered after the washing process has finished.

The operator of the mixing apparatus 10 can at any time perform a manual rinsing or cleaning operation when found necessary, e.g. between mixing of frozen desserts with different taste and/or color.

Whether a rinsing or washing operation is to be performed the valve at the bottom of the funnel 50 has to be open in order to perform either process.

The design of the valve is advantageous with regards to maintaining high hygiene and easy cleaning. By removing a cotter pin, a flat plate element closing the opening of the outlet of the funnel 50 can be easily removed from the funnel 50 to be cleaned. The valve is then open. The flat plate element can be placed in the sink 6 located below outlet of the valve of the funnel 50 of the mixing apparatus 10. The water from the nozzles located in the top chamber 60 will hit the spindle 30 and top chamber 60, pass through the mixing chamber 20, and will flow out into the sink 6 through the valve opening at the bottom of the funnel 50, thus flushing the valve part in the sink.

A method and device according to one or more embodiments of the present invention facilitates easy cleaning of all parts in contact with the frozen dessert, i.e. the valve parts, the funnel 50, the top chamber 60 and the spindle 30, in one controlled operation.

Variations of the embodiments as described above is possible and all such modifications as would be obvious for a skilled person are intended to be included within the scope of the invention as defined in the following claims.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for ensuring continuous and hygienic operation of a mixing apparatus for mixing frozen desserts in a mixing chamber formed by a top chamber and a funnel brought together, wherein a spindle with a driving portion is accommodated through said top chamber, said method comprising:
checking whether a predetermined time has passed since a last rinsing or washing operation has been performed;
disabling mixing operation and notifying that a rinsing and/or washing operation is required if the predetermined time has passed;
enabling mixing operation if the predetermined time has not passed;
initiating a rinsing process when selected;
initiating a washing process when selected, and
performing a mixing operation of frozen desserts when enabled and selected.

2. The method according to claim 1, wherein rinsing or washing process is performed by manual or automatic operation.

3. The method according to claim 1, wherein the rinsing process comprises:
bringing the funnel and the stationary top chamber together thus forming a closed mixing chamber;
rotating the spindle;
checking whether a valve at the bottom of the funnel is open;
applying water through water spray nozzles that are directed at the spindle if said valve is open, wherein said nozzles are mounted in the top chamber; and
lowering the funnel after the rinsing process has finished.

4. The method according to claim 1, wherein the washing process comprises:
bringing the funnel and the stationary top chamber together thus forming a closed mixing chamber;
rotating the spindle;
checking whether valve at the bottom of the funnel is open;
applying detergent and hot water through water spray nozzles that are directed at the spindle if said valve is open, wherein said nozzles are mounted in the top chamber; and
lowering the funnel after the washing process has finished.

5. A device for operating and controlling an apparatus for mixing frozen desserts in a closed mixing chamber formed by a top chamber and funnel with a valve at its bottom, wherein a spindle with a driving portion is accommodated in said top chamber, said device comprising:
a checking portion that checks whether a predetermined time has passed since last rinsing or washing operation has been performed;
a rinsing process portion that initiates a rinsing process when selected through input portion;
a washing process portion initiates a washing process when selected through the input portion, and
a mixing operation portion that performs a mixing operation of frozen desserts when enabled and selected through the input portion.

6. The device according to claim 5, wherein the device has a portion that is remotely operated and controlled.
